(19) United States
(12) Patent Application Publication
(10) Pub. No.: US 2025/0345900 A1
(43) Pub. Date: Nov. 13, 2025

(54) POWERED RATCHET WITH AUTOMATIC DIRECTIONAL SELECTOR

(71) Applicant: MILWAUKEE ELECTRIC TOOL CORPORATION, Brookfield, WI (US)

(72) Inventor: Kyle A. Marten, Plymouth, WI (US)

(21) Appl. No.: 19/207,041

(22) Filed: May 13, 2025

Related U.S. Application Data
(60) Provisional application No. 63/646,133, filed on May 13, 2024.

(51) Int. Cl. B25B 21/00; B25B 23/18; B25F 5/00; B25F 5/02

(52) U.S. Cl. CPC B25B 21/004; B25B 23/18; B25F 5/001; B25F 5/02

(57) ABSTRACT

A powered ratchet includes a motor having a motor shaft rotatable in forward and reverse directions coupled to a ratchet drive shaft with eccentric drive member coupled to the yoke of a ratchet assembly, the yoke reciprocates about an output drive axis in response to rotation of the ratchet drive shaft, an output drive selectively coupled to the yoke by a pawl mechanism such that in a first configuration, the output drive coupled for co-rotation with the yoke in a first direction and rotatable relative to the output drive in a second, opposite direction, and in a second configuration, the output drive is coupled for co-rotation with the yoke in the second direction, is rotatable relative to the output drive in the first direction, and an actuator operable to move the pawl mechanism between the first and second configurations in response to rotation of the motor shaft changing direction.

### CROSS-REFERENCE TO RELATED APPLICATIONS

This application claims priority to co-pending U.S. Provisional Patent Application No. 63/646,133 filed on May 13, 2024, the entire content of which is incorporated herein by reference.

### FIELD OF THE DISCLOSURE

The present disclosure relates to ratchets, and more particularly to powered ratchets.

### BACKGROUND OF THE DISCLOSURE

Ratchets are used to drive fasteners, particularly in tight spaces where 360-degree rotation of a wrench is not possible. Ratchets typically include a ratchet mechanism with a pawl and a drive (also referred to as an anvil) configured such that torque is transferred to the drive via the pawl in only one selected direction. The drive is permitted to rotate relative to the remainder of the tool in the opposite direction. Typical ratchets include a forward/reverse selector switch located on the head of the ratchet to mechanically change the position of a pawl. The position of the pawl determines in which direction torque is transferrable to the drive. However, because the head of the ratchet may not be readily accessible when the ratchet is used in a tight space, it may be difficult to access the forward/reverse selector switch.

### SUMMARY OF THE DISCLOSURE

The present disclosure provides, among other things, a powered ratchet that allows an operator to more easily and efficiently change an effective operating direction of the powered ratchet.

The present disclosure provides, in one aspect, a powered ratchet including: a housing; a motor having a motor shaft, the motor shaft being rotatable in a forward direction and a reverse direction; a ratchet drive shaft coupled to the motor shaft and including an eccentric drive member; a ratchet assembly including a yoke coupled to the eccentric drive member such that the yoke reciprocates about an output drive axis in response to rotation of the ratchet drive shaft, and an output drive selectively coupled to the yoke by a pawl mechanism such that: the output drive is coupled for co-rotation with the yoke in a first direction, and the yoke is rotatable relative to the output drive in a second direction opposite the first direction, when the pawl mechanism is in a first configuration, and the output drive is coupled for co-rotation with the yoke in the second direction, and the yoke is rotatable relative to the output drive in the first direction, when the pawl mechanism is in a second configuration; and an actuator operable to move the pawl mechanism between the first configuration and the second configuration in response to rotation of the motor shaft changing direction.

The present disclosure provides, in another aspect, a powered ratchet including: a housing; a motor having a motor shaft, the motor shaft being rotatable in a forward direction and a reverse direction; a ratchet drive shaft coupled to the motor shaft and including an eccentric drive member; a ratchet assembly including a yoke coupled to the eccentric drive member such that the yoke reciprocates about an output drive axis in response to rotation of the ratchet drive shaft, and an output drive selectively coupled to the yoke by a pawl mechanism such that: the output drive is coupled for co-rotation with the yoke in a first direction, and the yoke is rotatable relative to the output drive in a second direction opposite the first direction, when the pawl mechanism is in a first configuration, and the output drive is coupled for co-rotation with the yoke in the second direction, and the yoke is rotatable relative to the output drive in the first direction, when the pawl mechanism is in a second configuration; and an actuator operable to move the pawl mechanism between the first configuration and the second configuration in response to rotation of the motor shaft changing direction.

The present disclosure provides, in another aspect, a powered ratchet including: a housing; a motor having a motor shaft, the motor shaft being rotatable in a forward direction and a reverse direction; a ratchet assembly including a yoke coupled to the motor shaft such that the yoke reciprocates about an output drive axis in response to rotation of the motor shaft, and an output drive selectively coupled to the yoke by a pawl mechanism such that: the output drive is coupled for co-rotation with the yoke in a first direction, and the yoke is rotatable relative to the output drive in a second direction opposite the first direction, when the pawl mechanism is in a first configuration, and the output drive is coupled for co-rotation with the yoke in the second direction, and the yoke is rotatable relative to the output drive in the first direction, when the pawl mechanism is in a second configuration; and an actuator coupled to the motor shaft and receiving a rotational input therefrom, the actuator translating between a first position and a second position to move the pawl mechanism between the first configuration and the second configuration in response to rotation of the motor shaft changing directions.

In some aspects, the techniques described herein relate to a powered ratchet including: a housing; a motor having a motor shaft, the motor shaft being rotatable in a forward direction and a reverse direction; a ratchet drive shaft coupled to the motor shaft and including an eccentric drive member; a ratchet assembly including a yoke coupled to the eccentric drive member such that the yoke reciprocates about an output drive axis in response to rotation of the ratchet drive shaft, and an output drive selectively coupled to the yoke by a pawl mechanism such that: the output drive is coupled for co-rotation with the yoke in a first direction, and the yoke is rotatable relative to the output drive in a second direction opposite the first direction, when the pawl mechanism is in a first configuration, and the output drive is coupled for co-rotation with the yoke in the second direction, and the yoke is rotatable relative to the output drive in the first direction, when the pawl mechanism is in a second configuration; and an actuator operable to move the pawl mechanism between the first configuration and the second configuration in response to rotation of the motor shaft changing direction, the actuator movable between a forward drive position and a reverse drive position, wherein the pawl mechanism includes a forward drive pawl that engages the output drive when the actuator is in a forward drive position to define the first configuration of the pawl mechanism, and a reverse drive pawl that engages the output drive when the actuator is in a reverse drive position to define the second configuration of the pawl mechanism.

Other features and aspects of the disclosure will become apparent by consideration of the following detailed description and accompanying drawings.

### BRIEF DESCRIPTION OF THE DRAWINGS

FIG. 1 is a perspective view of a powered ratchet.

FIG. 2 is a side view of the powered ratchet of FIG. 1.

FIG. 3 is a side view of a ratchet head of the powered ratchet of FIG. 1.

FIG. 4 is a cross section view of the ratchet head of FIG. 3 taken along Line 4-4 in FIG. 3.

FIG. 5 is a partial cross section view of the ratchet head of FIG. 3 in a reverse drive position.

FIG. 6 is a partial cross section view of the ratchet head of FIG. 3 in a forward drive position.

FIG. 6A is a partial cross section view of a ratchet head

FIG. 7 is a side view of another ratchet head.

FIG. 8 is a cross section view of the ratchet head of FIG. 7 taken along Line 8-8 in FIG. 7.

FIG. 9 is a partial cross section view of the ratchet head of FIG. 7 a reverse drive position.

FIG. 10 is a partial cross section view of the ratchet head of FIG. 7 in a forward drive position.

FIG. 11 is a side view of an extended drive assembly.

FIG. 12 is a cross section view of the extended drive assembly of FIG. 11 taken along Line 12-12 in FIG. 11.

FIG. 13 is a perspective view of a powered ratchet tool according to another embodiment of the present disclosure.

FIG. 14 is a perspective view of the powered ratchet tool of FIG. 13 with portions removed.

FIG. 15 is an enlarged cross-sectional view of the powered ratchet tool of FIG. 13.

FIG. 16 is a cross-sectional view of the powered ratchet tool of FIG. 13.

FIG. 17 is a cross-sectional view of a motor shaft and an impeller of the powered ratchet tool of FIG. 13.

FIG. 18A is a perspective view of a bearing holder of the powered ratchet tool of FIG. 13.

FIG. 18B is a rear perspective view of the bearing holder of FIG. 18A.

Before any embodiments of the present disclosure are explained in detail, it is to be understood that the embodiments described herein are not limited in scope or application to the details of construction and the arrangement of components set forth in the following description or as illustrated in the following drawings. The devices described herein are capable of other embodiments and of being practiced or of being carried out in various ways. Also, it is to be understood that the phraseology and terminology used herein is for the purpose of description and should not be regarded as limiting.

### DETAILED DESCRIPTION

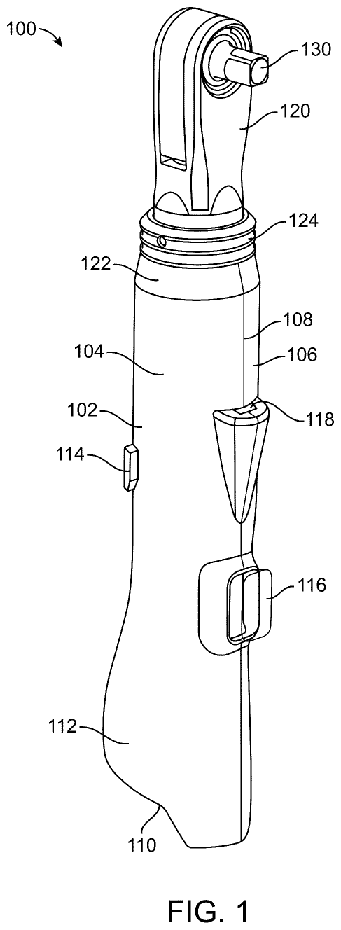

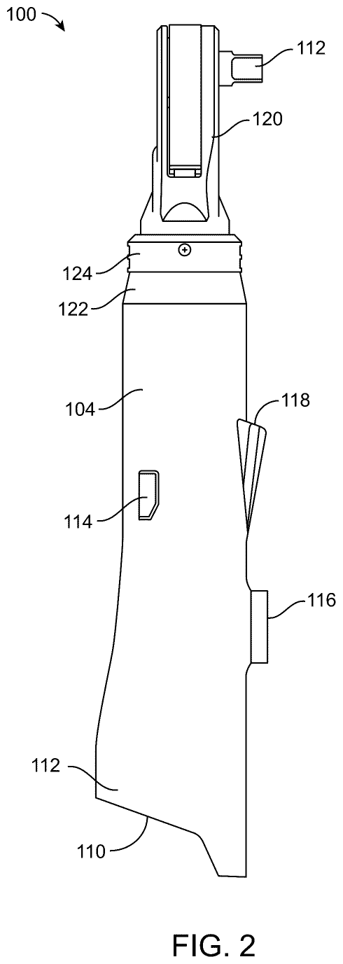

FIGS. 1 and 2 illustrate the details of a powered ratchet 100 that is used to install and remove threaded fasteners such as nuts and bolts. As shown, the powered ratchet 100 includes a housing 102 having a first housing portion 104 and a second housing portion 106 coupled thereto along a seam 108. The housing 102 includes a battery receptacle 110 at a lower end 112 of the housing 102. A battery pack (not shown) is removably engaged with the battery receptacle 110. The powered ratchet 100 further includes a motor rotation direction selector 114 that extends through the housing 102 and a power button 116 that is pressed, or released, to energize, or de-energize, the powered ratchet 100. A workpiece light 118 extends from the housing 102 and is illuminated when the power button 116 is pressed to provide light at a workpiece.

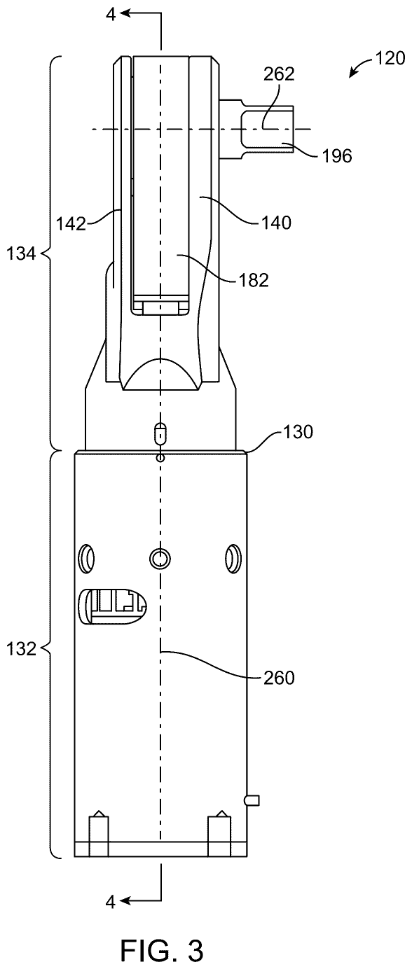

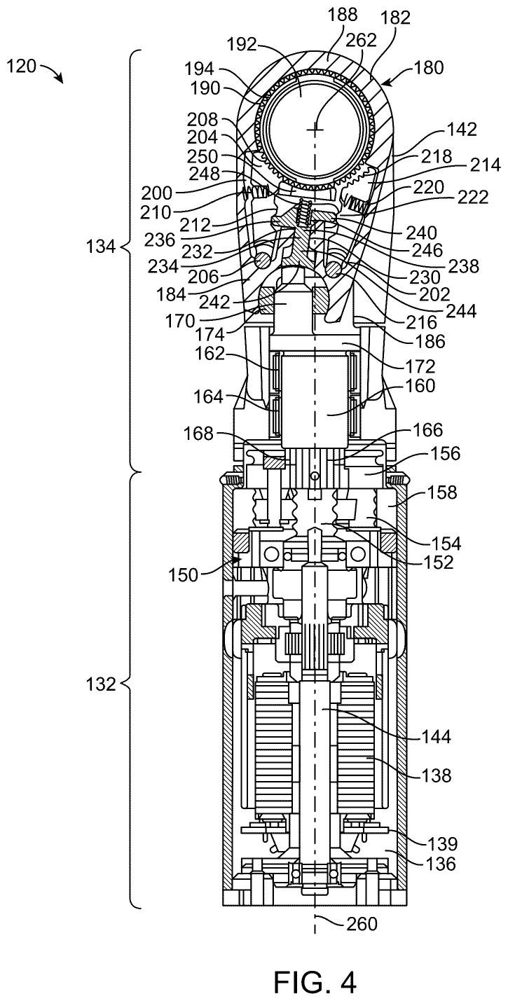

FIGS. 1 and 2 further illustrate that the powered ratchet 100 includes a ratchet head 120 that extends from an upper end 122 of the housing 102. A collar 124 circumscribes the interface where the ratchet head 120 meets the housing 102. The collar 124 may be manually moved to change the direction of operation of the powered ratchet 100. FIGS. 3 and 4 illustrate the details of the ratchet head 120. As shown, the ratchet head 120 includes a ratchet head housing 130 having a lower portion 132 and an upper portion 134. The lower portion 132 of the ratchet head housing 130 is hollow, generally cylindrical and includes an internal chamber 136 in which a motor 138 and a controller 139, e.g., a printed circuit board (PCB), are installed. The upper portion 134 of the ratchet head housing 130 includes a front support 140 and a rear support 142.

FIG. 4 shows that the motor 138 includes a motor shaft 144 that is engaged with a transmission 150. The transmission 150 includes a sun gear 152 that is coupled to an end of the motor shaft 144. The transmission 150 also includes a plurality of planet gears 154 surrounding the sun gear 152 and mounted on a rotating planet gear carrier 156. Further, the transmission 150 includes a fixed ring gear 158 that surrounds the planet gears 154 adjacent the rotating planet gear carrier 156. The sun gear 152, the planet gears 154, and the fixed ring gear 158 are each formed with helical teeth. As described in greater detail below, the planet gear carrier 156 moves up and down (with reference to the orientation illustrated in FIG. 4) and acts as an actuator to change a ratchet direction of the powered ratchet 100 depending on the rotation of the motor 138.

As further depicted in FIG. 4, the powered ratchet 100 includes a ratchet drive shaft 160. The ratchet drive shaft 160 is supported by an upper bearing 162 and a lower bearing 164. Moreover, the ratchet drive shaft 160 includes a splined lower end 166 that fits into a central, splined bore 168 formed in the center of the planet gear carrier 156. The ratchet drive shaft 160 further includes an eccentric drive member 170 that extends from a top 172 of the ratchet drive shaft 160. A drive bushing 174 fits around the eccentric drive member 170.

The powered ratchet 100 further includes a ratchet assembly 180 that is engaged with the ratchet drive shaft 160. Specifically, the ratchet assembly 180 includes a yoke 182 disposed between the front support 140 and rear support 142 of the upper portion 134 of the ratchet head housing 130. The yoke 182 includes a lower end 184 formed with an opening 186 that fits over the drive bushing 174. Further, the yoke 182 includes an upper end 188 formed with a bore 190 in which an output drive 192 is disposed. The output drive 192 includes a geared drive hub 194 that fits in the bore 190 of the yoke 182 and an output shaft or anvil 196 that extends from the geared drive hub 194.

The yoke 182 further includes a first lateral cavity 200 adjacent the bore 190 and a second lateral cavity 202 adjacent the bore 190 opposite the first lateral cavity 200. In the illustrated embodiment, the yoke 182 supports a pawl mechanism, including a forward drive pawl 204 and a reverse drive pawl 214. The forward drive pawl 204 is disposed within the first lateral cavity 200 and includes a lateral shaft 206 about which the forward drive pawl 204 rotates and a toothed face 208 opposite the lateral shaft 206 that is configured to selectively engage the teeth on the geared drive hub 194. A first spring 210 biases the forward drive pawl 204 toward the geared drive hub 194 of the output drive 192. The forward drive pawl 204 further includes a first protrusion 212. A reverse drive pawl 214 is disposed within the first lateral cavity 200 and includes a lateral shaft 216 about which the reverse drive pawl 214 rotates and a toothed face 218 opposite the lateral shaft 216 that is configured to selectively engage the teeth on the geared drive hub 194. A second spring 220 biases the reverse drive pawl 214 toward the geared drive hub 194 of the output drive 192. The reverse drive pawl 214 further includes a second protrusion 222. In other embodiments, the powered ratchet 100 may include other types of pawl mechanisms, such as a single pivoting rocker pawl.

The yoke 182 of the ratchet assembly 180 further includes a central bore 230 that extends between the first lateral cavity 200 and the second lateral cavity 202 to the opening 186 in the lower end 184 of the yoke 182. A direction selector 232 is slidably disposed within the central bore 230. The direction selector 232 includes a central post 234. A forward selector arm 236 extends from an upper end 238 of the central post 234 in a first direction toward the forward drive pawl 204. A reverse selector arm 240 extends from the upper end 238 of the central post 234 in a second direction, opposite the first direction, toward the reverse drive pawl 214. A rounded shifter plate 242 extends from a lower end 244 of the central post 234. The rounded shifter plate 242 is curved to match the curvature of the end of the eccentric drive member 170. The upper end 238 of the central post 234 includes a spring pocket 246. A shifter spring 248 is disposed within the spring pocket 246 between the base of the spring pocket 246 and a support plate 250 in the yoke 182 adjacent the bore 190.

During operation of the powered ratchet 100, when the motor 138 is energized, the motor shaft 144 rotates around a motor axis 260 in a forward direction (e.g., clockwise) or a reverse direction (e.g., counterclockwise) and the sun gear 152 rotates therewith. As the sun gear 152 rotates, the planet gears 154 rotate in an opposite direction within the fixed ring gear 158 and the planet gear carrier 156 rotates therewith. The ratchet drive shaft 160 rotates with the planet gear carrier 156 and as it rotates about the motor axis 260, the eccentric drive member 170 rotates around the motor axis 260 at a distance from the motor axis 260. The eccentric drive member 170 actuates the ratchet assembly 180. Specifically, the eccentric drive member 170 rotates the yoke 182 back-and-forth in a reciprocating manner around an output axis 262 that is perpendicular to the motor axis 260. As the yoke 182 moves back-and-forth, the toothed face 208 of the forward drive pawl 204, or the toothed face 218 of the reverse drive pawl 214, engages teeth on the geared drive hub 194 to rotate the output drive 192 around the output axis 262 in a first or forward direction, (i.e., clockwise), or a second or reverse direction, (i.e., counterclockwise). More specifically, when the forward drive pawl 204 is engaged with the geared drive hub 194 (i.e., in a first configuration of the pawl mechanism), the geared drive hub 194 (and the output shaft 196 of the output drive 192) only co-rotates with the yoke 182 in the forward direction. That is, the yoke 182 is rotatable relative to the geared drive hub 194 in the reverse direction in the first configuration of the pawl mechanism. Conversely, when the reverse drive pawl 214 is engaged with the geared drive hub 194 (i.e., in a second configuration of the pawl mechanism), the geared drive hub 194 (and the output shaft 196 of the output drive 192) only co-rotates with the yoke 182 in the reverse direction. That is, the yoke 182 is rotatable relative to the geared drive hub 194 in the forward direction in the second configuration of the pawl mechanism. A tool element, such as a socket (not shown) can be engaged with the output shaft 196 to rotate therewith.

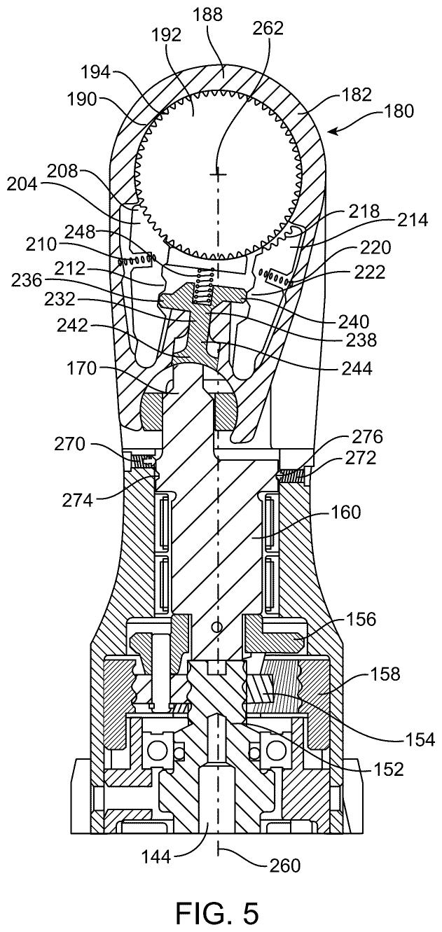

Depending on the rotation direction of the motor shaft 144, the helical teeth of the sun gear 152, the planet gears 154, and the fixed ring gear 158 allow the planet gears 154 to move upward or downward, linearly, along the motor axis 260 around the sun gear 152 and within the fixed ring gear 158. The planet gears 154 and the planet gear carrier 156 act as an actuator and this actuator moves along the motor axis 260 between a forward drive position and a reverse drive position. In the forward drive position, depicted in FIG. 5, the planet gears 154 and the planet gear carrier 156 (aka, the actuator) are shifted downward within the ratchet head housing 130 and the ratchet drive shaft 160 is shifted downward as well. The shifter spring 248 biases the direction selector 232 downward, away from the output drive 192, and the forward selector arm 236 slides off of the first protrusion 212 on the forward drive pawl 204. The first spring 210 biases the forward drive pawl 204 toward the output drive 192 so that the toothed face 208 of the forward drive pawl 204 is engaged with teeth on the geared drive hub 194. At the same time, the reverse selector arm 240 engages the second protrusion 222 on the reverse drive pawl 214 and pushes the reverse drive pawl 214 away from the output drive 192 so that the toothed face 218 on the reverse drive pawl 214 is disengaged from the teeth of the geared drive hub 194.

Accordingly, as the motor 138 rotates in a counterclockwise direction, the forward drive pawl 204 continuously engages and disengages the geared drive hub 194 of the output drive 192 to drive the output drive 192 so that the output shaft 196 rotates in a forward, or clockwise, direction. The forward drive pawl 204 prevents the output drive 192 from rotating in a reverse, or counterclockwise direction.

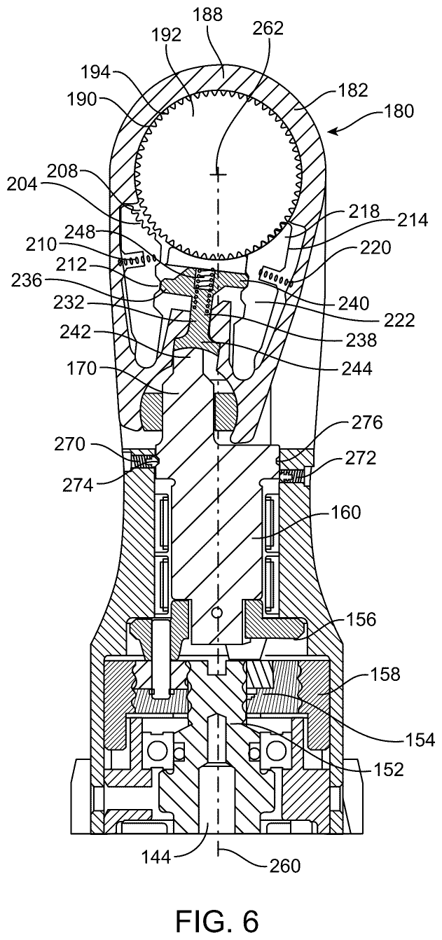

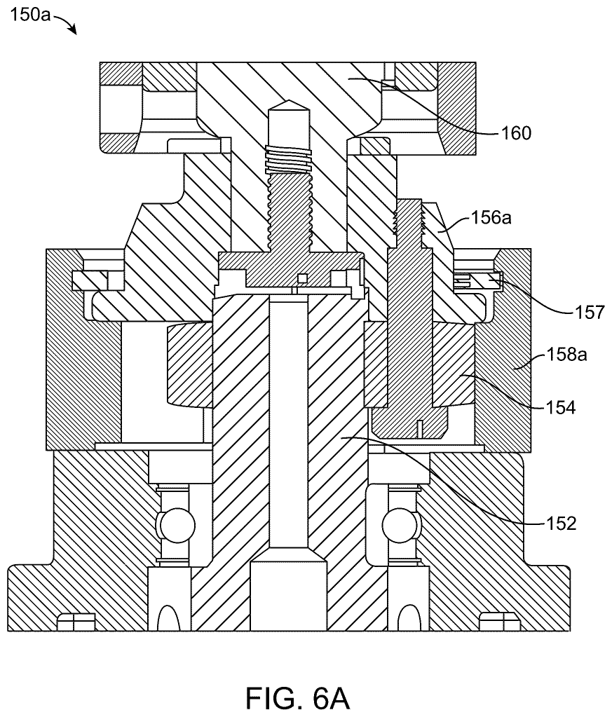

When the direction of rotation of the motor 138 switches to forward, the planet gears 154, the planet gear carrier 156, and the ratchet drive shaft 160 move to the reverse drive position. In the reverse drive position, illustrated in FIG. 6, the planet gears 154 and the planet gear carrier 156 (aka, the actuator) are shifted upward within the ratchet head housing 130 and the ratchet drive shaft 160 is shifted upward as well. The rounded end of the eccentric drive member 170 engages the rounded shifter plate 242 and pushes the direction selector 232 upward against the shifter spring 248 toward the output drive 192. The reverse selector arm 240 slides off of the second protrusion 222 on the reverse drive pawl 214. The second spring 220 biases the reverse drive pawl 214 toward the output drive 192 so that the toothed face 218 of the reverse drive pawl 214 is engaged with teeth on the geared drive hub 194. At the same time, the forward selector arm 236 engages the first protrusion 212 on the forward drive pawl 204 and pushes the forward drive pawl 204 away from the output drive 192 so that the toothed face 208 on the forward drive pawl 204 is disengaged from the teeth of the geared drive hub 194.

Accordingly, as the motor 138 rotates in a clockwise direction, the reverse drive pawl 214 continuously engages and disengages the geared drive hub 194 of the output drive 192 to drive the output drive 192 so that the output shaft 196 rotates in a reverse, or counterclockwise, direction. The reverse drive pawl 214 prevents the output drive 192 from rotating in a forward, or clockwise direction.

It is to be understood that the planet gear carrier 156 may be coupled to an external slider, e.g., the collar 124, that may be used to manually change the direction of rotation of the powered ratchet 100. Further, it is to be understood that the helical gear teeth of the sun gear 152, the planet gears 154, the fixed ring gear 158, may be replaced with straight cut gear teeth, and, in such a case, the direction of rotation of the output drive 192 of the powered ratchet 100 may be changed by manually moving an external slider, e.g., the collar 124, affixed to the planet gear carrier 156 and accessible from the exterior of the housing 102 of the powered ratchet 100.

FIGS. 5 and 6 further illustrate that the ratchet head 120 includes a forward detent assembly 270 and a reverse detent assembly 272. In the forward drive position, shown in FIG. 5, the forward detent assembly 270 engages a forward depression 274 formed in the ratchet drive shaft 160. In the reverse drive position, shown in FIG. 6, the reverse detent assembly 272 engages a reverse depression 276 formed in the ratchet drive shaft 160 opposite the forward depression 274. The forward detent assembly 270 and the reverse detent assembly 272 engage the forward depression 274 and the reverse depression 276, respectively, to maintain the powered ratchet 100 in the forward drive position or the reverse drive position, for example, against the spring 248, while still allowing the ratchet head 120 to shift rotational directions under the axial force provided by the helical gear teeth of the sun gear 152, the planet gears 154, the fixed ring gear 158.

During operation, a user may move, or shift, the motor rotation direction selector 114 to a forward position. The electronics on the controller 139 recognize the position of the motor rotation direction selector 114 and spins the motor 138 a partial revolution (or enough) in a forward direction for the axial force of the helical gear teeth of the sun gear 152, the planet gears 154, the fixed ring gear 158 to shift the transmission 150 to the forward drive position. The forward detent assembly 270 would retain this position and the user may press the power button 116 to tighten a fastener (for clockwise threads) or the user may tighten the fastener by hand. Conversely, a user may move, or shift, the motor rotation direction selector 114 to a reverse position. The electronics on the controller 139 recognize the position of the motor rotation direction selector 114 and spins the motor 138 a partial revolution (or enough) in a reverse direction for the axial force of the helical gear teeth of the sun gear 152, the planet gears 154, the fixed ring gear 158 to shift the transmission 150 to the reverse drive position. The reverse detent assembly 272 would retain this position and the user may press the power button 116 to loosen a fastener (for clockwise threads) or the user may loosen the fastener by hand.

FIG. 6A illustrates another embodiment of a transmission 150a that is substantially similar to transmission 150, except as described otherwise below. The transmission 150a includes a sun gear 152 that is coupled to an end of the motor shaft 144. The transmission 150 also includes a plurality of planet gears 154 surrounding the sun gear 152 and mounted on a rotating planet gear carrier 156a. Further, the transmission 150a includes a ring gear 158a that surrounds the planet gears 154 adjacent the rotating planet gear carrier 156a. The ring gear 158a is coupled to the planet gear carrier 156a (e.g., with a spring clip 157) to translate with the planet gear carrier 156a and is fixed against rotation. In the present embodiment, the sun gear 152, the planet gears 154, and the ring gear 158a are each formed with straight teeth, but may instead have another tooth geometry, such as helical teeth. As described in greater detail below, the planet gear carrier 156a moves up and down (with reference to the orientation illustrated in FIG. 6A) and acts as an actuator to change a ratchet direction.

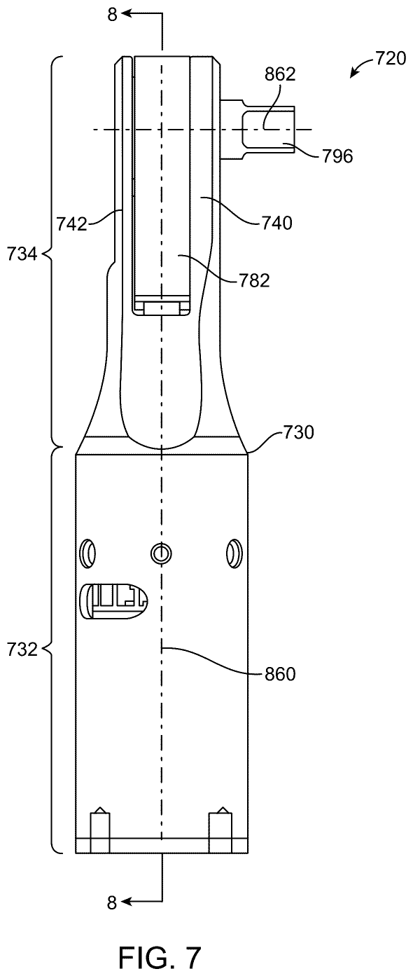

Referring now to FIGS. 7-10, another ratchet head 720 that can be used within the powered ratchet 100, in lieu of the previously described ratchet head 120, is depicted. As shown, the ratchet head 720 includes a ratchet head housing 730 having a lower portion 732 and an upper portion 734. The lower portion 732 of the ratchet head housing 730 is hollow, generally cylindrical and includes an internal chamber 736 in which a motor 738 is installed. The upper portion 734 of the ratchet head housing 730 includes a front support 740 and a rear support 742.

FIG. 4 shows that the motor 738 includes a motor shaft 744 that is engaged with a transmission 750. The transmission 750 includes a sun gear 752 that is coupled to an end of the motor shaft 744. The transmission 750 also includes a plurality of planet gears 754 surround the sun gear 752 and are mounted on a rotating planet gear carrier 756. Further, the transmission 750 includes a fixed ring gear 758 that surrounds the planet gears 754 adjacent the rotating carrier 756. The sun gear 752, the planet gears 754, and the fixed ring gear 758 are each formed with straight cut teeth. Moreover, while sun gear 752 and the planet gears 754 rotate, they do not translate linearly along an axis.

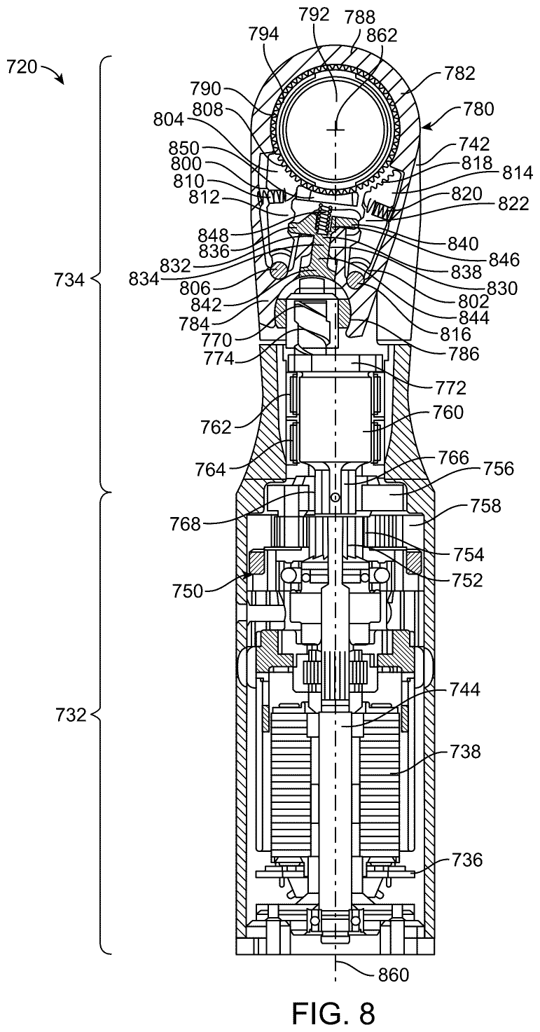

As further depicted in FIG. 8-10, the ratchet head 720 includes a ratchet drive shaft 760. The ratchet drive shaft 760 is supported by an upper bearing 762 and a lower bearing 764. Moreover, the ratchet drive shaft 760 includes a splined lower end 766 that fits into a central, splined bore 768 formed in the center of the planet gear carrier 756. The ratchet drive shaft 760 further includes an eccentric drive member 770 that extends from a top 772 of the ratchet drive shaft 760. The eccentric drive member 770 is formed with an external thread 774. An actuator 776 formed with a complementary internal thread 777 fits over, and rotates on, the eccentric drive member 770. A drive bushing 778 fits around the actuator 776. As described in greater detail below, the actuator 776 moves up and down to change a ratchet direction of the ratchet head 720 depending on the rotation of the motor 738.

The ratchet head 720 further includes a ratchet assembly 780 that is engaged with the ratchet drive shaft 760. Specifically, the ratchet assembly 780 includes a yoke 782 disposed between the front support 740 and rear support 742 of the upper portion 734 of the ratchet head housing 730. The yoke 782 includes a lower end 784 formed with an opening 786 that fits over the drive bushing 778. Further, the yoke 782 includes an upper end 788 formed with a bore 790 in which an output drive 792 is disposed. The output drive 792 includes a geared drive hub 794 that fits in the bore 790 of the yoke 782 and an output shaft 796 that extends from the geared drive hub 794.

The yoke 782 further includes a first lateral cavity 800 adjacent the bore 790 and a second lateral cavity 802 adjacent the bore 790 opposite the first lateral cavity 800. The yoke 782 supports a pawl mechanism including a forward drive pawl 804 and a reverse drive pawl 814. The forward drive pawl 804 is disposed within the first lateral cavity 800 and includes a lateral shaft 806 about which the forward drive pawl 804 rotates and a toothed face 808 opposite the lateral shaft 806 that is configured to selectively engage the teeth on the geared drive hub 794. A first spring 810 biases the forward drive pawl 804 toward the geared drive hub 794 of the output drive 792. The forward drive pawl 804 further includes a first protrusion 812. A reverse drive pawl 814 is disposed within the first lateral cavity 800 and includes a lateral shaft 816 about which the reverse drive pawl 814 rotates and a toothed face 818 opposite the lateral shaft 816 that is configured to selectively engage the teeth on the geared drive hub 794. A second spring 820 biases the reverse drive pawl 814 toward the geared drive hub 794 of the output drive 792. The reverse drive pawl 814 further includes a second protrusion 822. In other embodiments, the ratchet head 720 may include other pawl mechanisms, such as a single pivoting rocker pawl.

The yoke 782 of the ratchet assembly 780 further includes a central bore 830 that extends between the first lateral cavity 800 and the second lateral cavity 802 to the opening 786 in the lower end 784 of the yoke 782. A direction selector 832 is slidably disposed within the central bore 830. The direction selector 832 includes a central post 834. A forward selector arm 836 extends from an upper end 838 of the central post 834 in a first direction toward the forward drive pawl 804. A reverse selector arm 840 extends from the upper end 838 of the central post 834 in a second direction, opposite the first direction, toward the reverse drive pawl 814. A rounded shifter plate 842 extends from a lower end 844 of the central post 834. The rounded shifter plate 842 is curved to match the curvature of the end of the eccentric drive member 770. The upper end 838 of the central post 834 includes a spring pocket 846. A shifter spring 848 is disposed within the spring pocket 846 between the base of the spring pocket 846 and a support plate 850 in the yoke 782 adjacent the bore 790.

During operation of the powered ratchet 100 with the ratchet head 720, when the motor 738 is energized, the motor shaft 744 rotates around a motor axis 860 and the sun gear 752 rotates therewith. As the sun gear 752 rotates, the planet gears 754 rotate in an opposite direction within the fixed ring gear 758 and the planet gear carrier 756 rotates therewith. The ratchet drive shaft 760 rotates with the planet gear carrier 756 and as it rotates about the motor axis 860, the eccentric drive member 770 rotates around the motor axis 860 at a distance from the motor axis 860. The eccentric drive member 770 actuates the ratchet assembly 780. Specifically, the eccentric drive member 770 rotates the yoke 782 back-and-forth around an output axis 862 that is perpendicular to the motor axis 860. As the yoke 782 moves back-and-forth, the toothed face 808 of the forward drive pawl 804, or the toothed face 818 of the reverse drive pawl 814, engages teeth on the geared drive hub 794 to rotate the output drive 792 around the output axis 862 in a forward direction, i.e., clockwise, or a reverse direction, i.e., counterclockwise. If the forward drive pawl 804 is engaged with the geared drive hub 794, the geared drive hub 794 (and the output shaft 796 of the output drive 792) only rotates in the forward direction. Likewise, if the reverse drive pawl 814 is engaged with the geared drive hub 794, the geared drive hub 794 (and the output shaft 796 of the output drive 792) only rotates in the reverse direction. A socket (not shown) can be engaged with the output shaft 796 to rotate therewith.

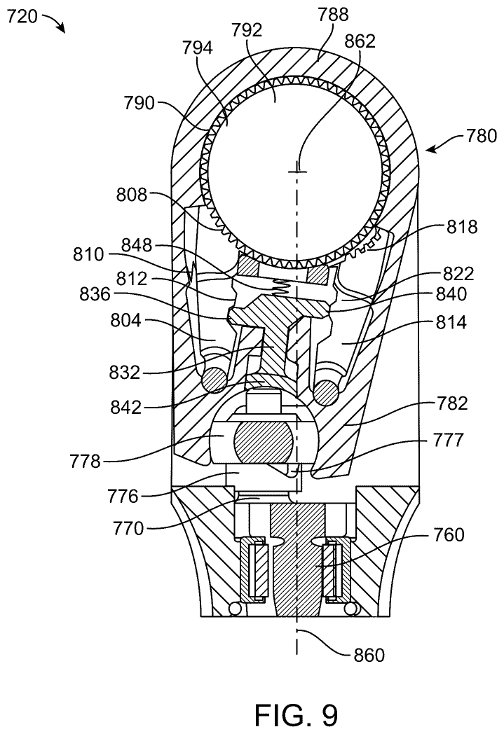

Depending on the rotation direction of the motor shaft 744, the external thread 774 on the eccentric drive member 770 cooperates with the internal thread 777 on the actuator 776 to allow the actuator 776 to move upward or downward, linearly, on the eccentric drive member 770, in a direction parallel to the motor axis 860. The actuator 776 moves along an axis parallel to the motor axis 860 between a forward drive position and a reverse drive position. In the forward drive position, shown in FIG. 9, the actuator 776 is shifted downward. The shifter spring 848 biases the direction selector 832 downward, away from the output drive 792, and the forward selector arm 836 slides off of the first protrusion 812 on the forward drive pawl 804. The first spring 810 biases the forward drive pawl 804 toward the output drive 792 so that the toothed face 808 of the forward drive pawl 804 is engaged with teeth on the geared drive hub 794. At the same time, the reverse selector arm 840 engages the second protrusion 822 on the reverse drive pawl 814 and pushes the reverse drive pawl 814 away from the output drive 792 so that the toothed face 818 on the reverse drive pawl 814 is disengaged from the teeth of the geared drive hub 794.

Accordingly, as the motor 738 rotates in a counterclockwise direction, the forward drive pawl 804 continuously engages and disengages the geared drive hub 794 of the output drive 792 to drive the output drive 792 so that the output shaft 796 rotates in a forward, or clockwise, direction. The forward drive pawl 804 prevents the output drive 792 from rotating in a reverse, or counterclockwise direction.

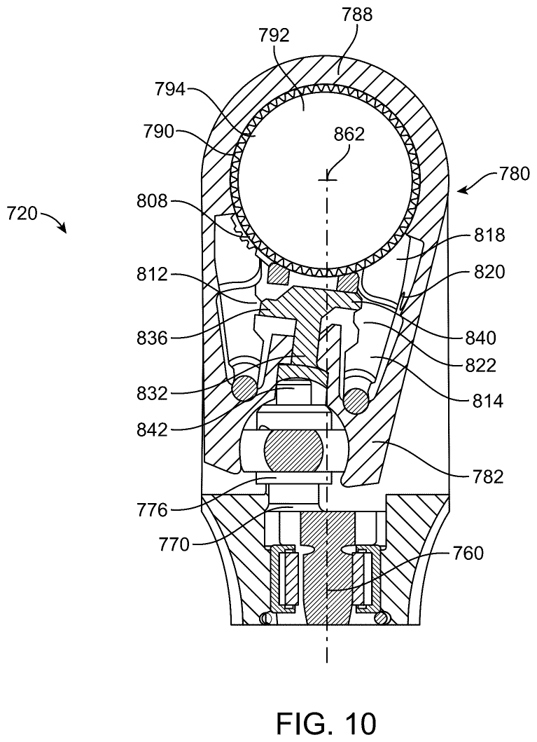

When the direction of rotation of the motor 738 switches to forward, the actuator 776 moves to the reverse drive position. In the reverse drive position, shown in FIG. 10, the internal thread 777 of the actuator 776 moves on the external thread 774 of the eccentric drive member 770 and actuator 776 rotates and is shifted upward. The rounded end of the actuator 776 engages the rounded shifter plate 842 and pushes the direction selector 832 upward against the shifter spring 848 toward the output drive 792. The reverse selector arm 840 slides off of the second protrusion 822 on the reverse drive pawl 814. The second spring 820 biases the reverse drive pawl 814 toward the output drive 792 so that the toothed face 818 of the reverse drive pawl 814 is engaged with teeth on the geared drive hub 794. At the same time, the forward selector arm 836 engages the first protrusion 812 on the forward drive pawl 804 and pushes the forward drive pawl 804 away from the output drive 792 so that the toothed face 808 on the forward drive pawl 804 is disengaged from the teeth of the geared drive hub 794.

Accordingly, as the motor 738 rotates in a clockwise direction, the reverse drive pawl 814 continuously engages and disengages the geared drive hub 794 of the output drive 792 to drive the output drive 792 so that the output shaft 796 rotates in a reverse, or counterclockwise, direction. The reverse drive pawl 814 prevents the output drive 792 from rotating in a forward, or clockwise direction.

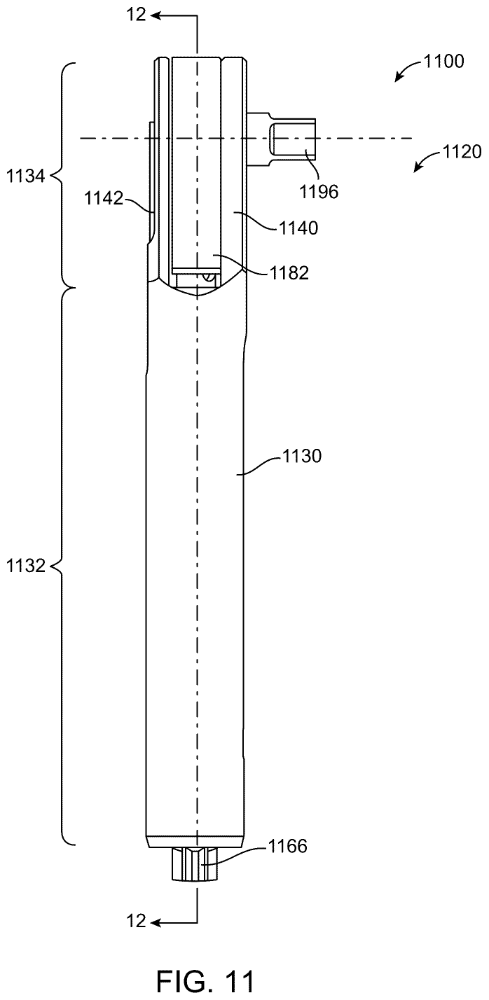

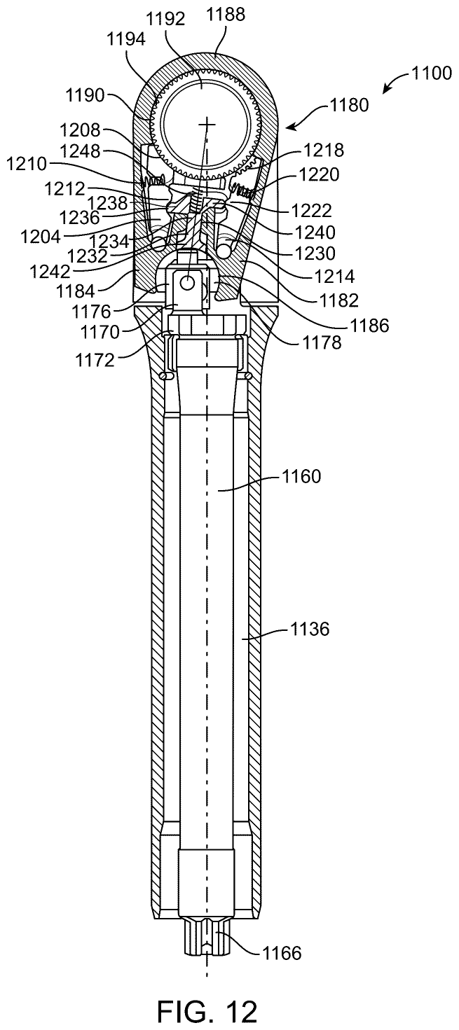

Referring lastly to FIGS. 11 and 12, an extended drive assembly 1120 is depicted. Features of the extended drive assembly 1120 are usable with the ratchet head 720 described above. As shown, the extended drive assembly 1120 includes a ratchet head housing 1130 having an extended lower portion 1132 and an upper portion 1134. The extended lower portion 1132 of the ratchet head housing 1130 is hollow, generally cylindrical, and includes an internal chamber 1136. The upper portion 1134 of the ratchet head housing 1130 includes a front support 1140 and a rear support 1142.

As shown in FIG. 12, the extended drive assembly 1100 includes an extended ratchet drive shaft 1160 is disposed within the extended lower portion drive shaft housing 1132 and a splined lower end 1166 that fits into a central, splined bore formed in a planet gear carrier (e.g., the planet gear carrier 756 described above). The extended ratchet drive shaft 1160 further includes an eccentric drive member 1170 that extends from a top 1172 of the extended ratchet drive shaft 1160. The eccentric drive member 1170 is formed with an external thread. An actuator 1176 formed with a complementary internal thread fits over, and rotates on, the eccentric drive member 1170. A drive bushing 1178 fits around the actuator 1176. The actuator 1176 moves up and down to change a ratchet direction of the ratchet head 1120 depending on the rotation of the motor 1138 (similar to motor 138).

The ratchet head 1120 further includes a ratchet assembly 1180 that is engaged with the extended ratchet drive shaft 1160. Specifically, the ratchet assembly 1180 includes a yoke 1182 disposed between the front support 1140 and rear support 1142 of the upper portion 1134 of the ratchet head housing 1130. The yoke 1182 includes a lower end 1184 formed with an opening 1186 that fits over the drive bushing 1176. Further, the yoke 1182 includes an upper end 1188 formed with a bore 1190 in which an output drive 1192 is disposed. The output drive 1192 includes a geared drive hub 1194 that fits in the bore 1190 of the yoke 1182 and an output shaft 1196 that extends from the geared drive hub 1194.

The yoke 1182 further includes a pawl mechanism including a forward drive pawl 1204 with a toothed face 1208 and a reverse drive pawl 1214 with a toothed face 1218. A first spring 1210 biases the forward drive pawl 1204 toward the geared drive hub 1194 of the output drive 1192. The forward drive pawl 1204 further includes a first protrusion 1212. The yoke also includes a reverse drive pawl 1214. A second spring 1220 biases the reverse drive pawl 1214 toward the geared drive hub 1194 of the output drive 1192. The reverse drive pawl 1214 further includes a second protrusion 1222.

The yoke 1182 of the ratchet assembly 1180 further includes a central bore 1230 and a direction selector 1232 is slidably disposed within the central bore 1230. The direction selector 1232 a forward selector arm 1236 and a reverse selector arm 1240 extends from the upper end 1238 of the central post 1234 in a second direction, opposite the first direction, toward the reverse drive pawl 1214. The direction selector 1232 also includes a rounded shifter plate 1242 that is curved to match the curvature of the end of the eccentric drive member 1170. A shifter spring 1248 is disposed adjacent the direction selector 1232 to bias the direction selector 1232 in a generally downward direction.

It is to be understood that the extended drive assembly 1100 operates in a manner similar to the ratchet head 720 described above. Specifically, the actuator 1176 moves up and down between a forward drive position and a reverse drive position to change a ratchet direction.

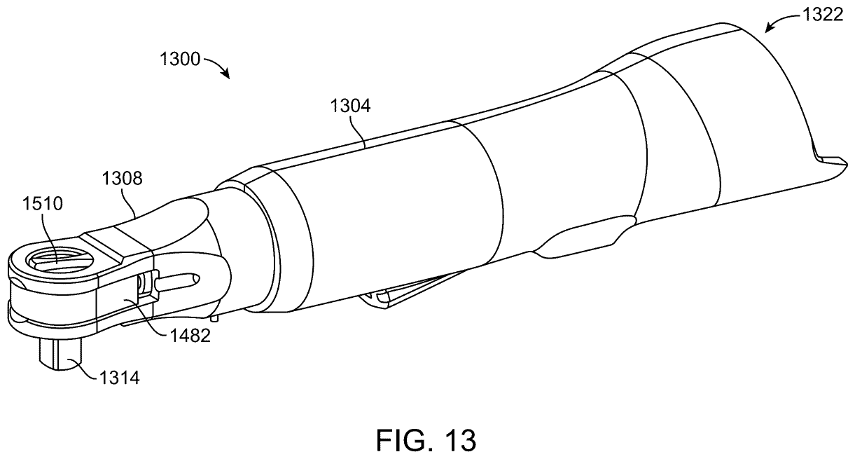

FIG. 13 illustrates another powered ratchet tool 1300 including a housing 1302 having a handle housing 1304 and a head 1308 (i.e., yoke housing) coupled to the handle housing 1304. The handle housing 1304 serves as a handle configured to be grasped by a user during operation. The head 1308 extends into the handle housing 1304 such that a portion of the head 1308 is surrounded by the handle housing 1304. The ratchet tool 1300 further includes a motor 1312 supported within the head 1308, an output drive 1314 rotatably supported by the head 1308, and a battery pack (not shown) received by a battery receptacle 1322 formed in the handle housing 1304 opposite the head 1308. The battery receptacle 1322 electrically connects the battery pack to the motor 1312 (via suitable electrical and electronic components, such as a PCBA containing MOSFETs, IGBTs, or the like).

The battery pack may be a 12-volt power tool battery pack that includes three lithium-ion battery cells. Alternatively, the battery pack may include fewer or more battery cells to yield any of a number of different output voltages (e.g., 14.4 volts, 18 volts, etc.). Additionally, or alternatively, the battery cells may include chemistries other than lithium-ion such as, for example, nickel cadmium, nickel metal-hydride, or the like. The ratchet tool 1300 also includes an actuator (not shown) for controlling operation of the ratchet tool 1300 (e.g., to energize/de-energize the motor 1312). The actuator may be a push-button that can be depressed into the handle housing 1304 to energize the motor 1312. The actuator may be arranged such that the actuator extends from the handle housing 1304 in the same direction as the output drive 1314.

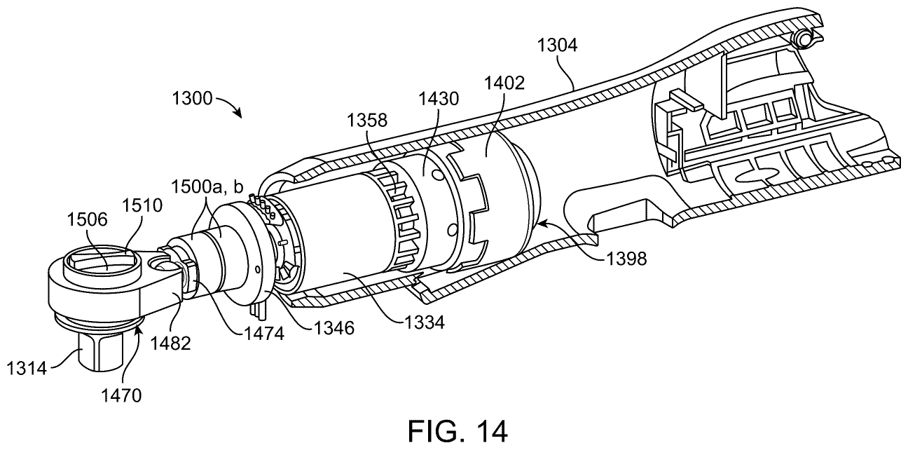

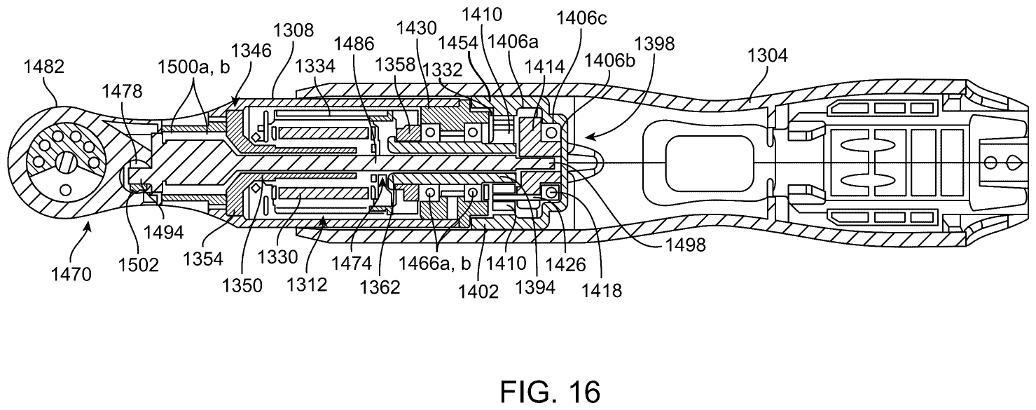

With reference to FIGS. 14-16, the motor 1312 is a brushless DC (BLDC) electric motor. The motor 1312 includes an internal stator 1330 and an external or outer rotor 1334 that circumferentially surrounds at least a portion of the internal stator 1330. The outer rotor 1334 extends longitudinally along a first axis or motor axis 1338, such that the internal stator 1330 and the outer rotor 1334 are coaxial about the motor axis 1338. The outer rotor 1334 rotates relative to the internal stator 1330 about the motor axis 1338 during operation of the ratchet tool 1300. The motor 1312 is configured to provide torque to the output drive 1314 to drive rotation of the output drive 1314 about a second axis or output axis 1342 oriented perpendicular to the motor axis 1338.

The internal stator 1330 is fixed within the head 1308 by a bracket 1346 fastened to the head 1308 to be oriented along the motor axis 1338. The bracket 1346 includes a shaft 1350 coupled to the internal stator 1330 and a flange 1354 integrally formed with and extending from the shaft 1350. The flange 1354 is fastened to the head 1308 by fasteners (e.g., screws; not shown) such that the bracket 1346 functions as a cantilever. Additionally, the bracket 1346 has a frustoconical shape when transitioning from the from the shaft 1350 to the flange 1354.

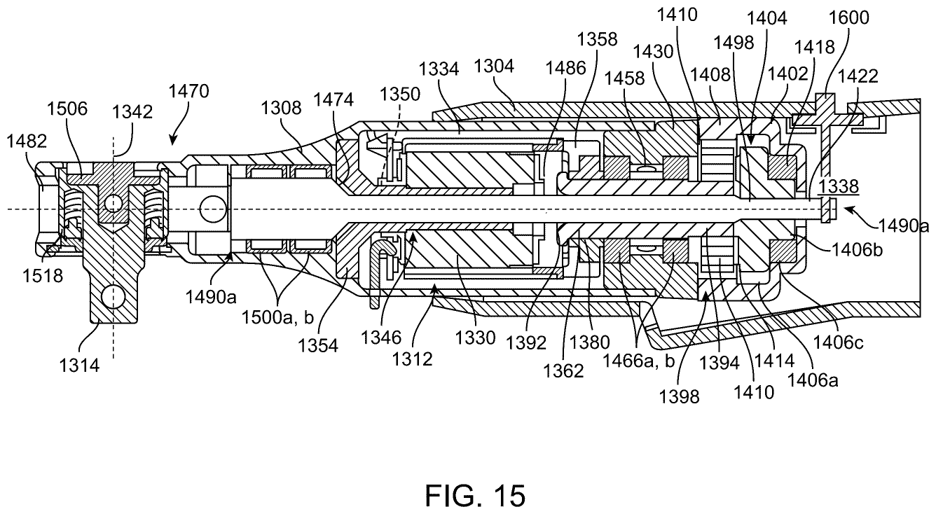

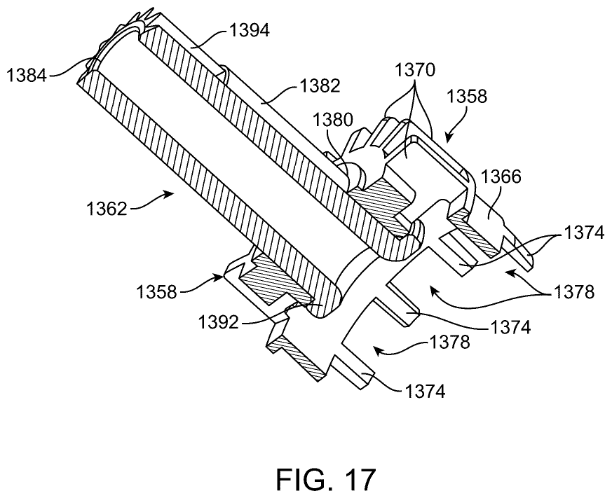

With reference to FIGS. 15-17, the motor 1312 further includes an impeller 1358 rotatably coupled to the outer rotor 1334 and a motor shaft 1362 coupled to the impeller 1358. The impeller 1358 includes a fan body 1366, a plurality of fan blades 1370 extending from the fan body 1366, and a plurality of projections 1374 from the fan body 1366 in a direction opposite the plurality of fan blades 1370. Multiple recesses 1378 are respectively defined between adjacent projections 1374. Each recess 1378 is configured to receive a portion of the outer rotor 1334, thereby coupling the impeller 1358 to the motor 1312 for co-rotation. The impeller 1358 further includes a central bore 1380 defined at a central portion of the plurality of fan blades 1370. The motor shaft 1362 includes a body 1382 with a bore 1384 extending therethrough and a flange 1392 configured to engage a portion of the impeller 1358 such that the body 1382 of the motor shaft 1362 is arranged to extend through the central bore 1380. As such, the motor shaft 1362 is coupled to the impeller 1358 for co-rotation about the motor axis 1338. Also, the motor shaft 1362 includes an external gear 1394 configured to engage a transmission or gear assembly 1398 of the ratchet tool 1300 discussed further in detail herein below.

With reference back to FIGS. 14-16, the gear assembly 1398 is at least partially disposed within the handle housing 1304 and arranged rearward of the motor 1312. The gear assembly 1398 includes a gear housing 1402 defining a cavity 1404 delimited by multiple walls 1406a-c formed therein. In particular, the walls 1406a-c of the gear housing 1402 are made of a first wall 1406a, a second wall 1406b serving as a base for the gear housing 1402, and an intermediate wall 1406c disposed between and integrally formed with the first and second walls 1406a, 1406b. A step like structure is formed between the first wall 1406a and the intermediate wall 1406c.

Also, the gear assembly 1398 has a ring gear 1408 formed in the first wall 1406a of the gear housing 1402, a plurality of planet gears 1410, and a planet carrier 1414 positioned on the second wall 1406b of the gear housing 1402 and rotatably supported by a bearing 1418 (e.g., roller bearing). The planet carrier 1414 has an internal gear 1422 centrally disposed within the planet carrier 1414 to be arranged about the motor axis 1338. Multiple pins 1426 (only one pin is illustrated) are configured to be received within the planet carrier 1414 and couple the plurality of planet gears 1410 with the planet carrier 1414. The planet gears 1410 are arranged within the cavity 1404 of the gear housing 1402 to engage the external gear 1394 of the motor shaft 1362 and the ring gear 1408. As such, the motor shaft 1362 is configured to transfer torque from the motor 1312 to the gear assembly 1398.

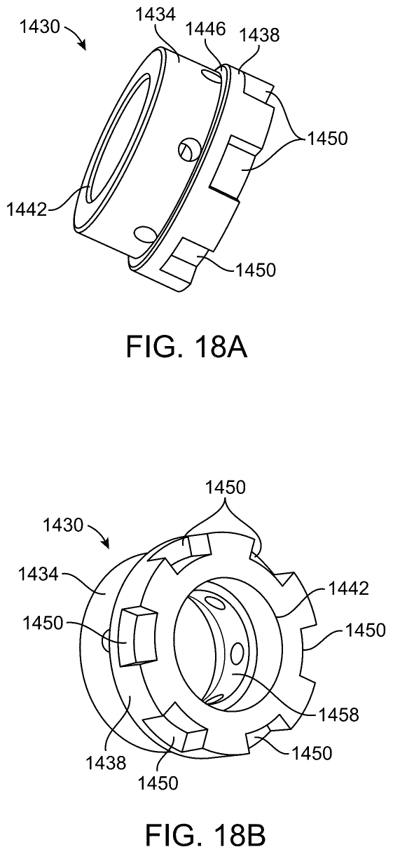

With reference to FIGS. 14-16, 18A, and 18B, the ratchet tool 1300 further includes a bearing holder 1430 disposed between the head 1308 and the gear housing 1402. A sealing member (not shown) is disposed between the gear housing 1402 and the bearing holder 1430 to seal the cavity 1404 of the gear housing 1402. The bearing holder 1430 has a first portion 1434, a second portion 1438 integrally formed with the first portion 1434, and a bore 1442 extending therethrough. A step-like feature is disposed between the first portion 1434 and the second portion 1438 of the bearing holder 1430 to form an abutment surface 1446. The head 1308 of the ratchet tool 1300 is coupled to the first portion 1434 of the bearing holder 1430 such that the head 1308 receives the first portion 1434 and the head 1308 is positioned against the abutment surface 1446. The gear housing 1402 of the gear assembly 1398 is coupled to the second portion 1438 of the bearing holder 1430 via corresponding engagement features. More specifically, the second portion 1438 of the bearing holder 1430 has a plurality of grooves 1450 configured to receive a plurality of projections 1454 formed along the gear housing 1402 to couple the gear housing 1402 to the bearing holder 1430. In other embodiments, the gear housing 1402 may include other coupling features for coupling the gear housing 1402 to the handle housing 1304.

Also, the bearing holder 1430 has an internal surface 1458 which is a radially inward extending surface formed along the bore 1442 at a central portion of the bearing holder 1430. A pair of bearings 1466a, 1466b are arranged within the bore 1442 of the bearing holder 1430 and disposed on opposite sides of the internal surface 1458. The motor shaft 1362 extends through the bearing holder 1430 and into the gear housing 1402 so that the external gear 1394 of the motor shaft 1362 engages the plurality of planet gears 1410. As such, the pair of bearings 1466a, 1466b are provided to rotatably support the motor shaft 1362.

With reference to FIGS. 13-16, the powered ratchet tool 1300 includes a ratchet mechanism 1470 supported by the head 1308. The ratchet mechanism 1470 includes a crankshaft 1474, a drive bushing 1478 operably coupled to the crankshaft 1474, and a yoke 1482 through which the output drive 1314 extends. The crankshaft 1474 has a body 1486 defining a first end 1490a and a second end 1490b of the crankshaft 1474, an eccentric member 1494 formed on the body 1486 at the first end 1490a, and a pinion 1498 formed on the body 1486 at the second end 1490b opposite the first end 1490a. The crankshaft 1474 is arranged within the ratchet tool 1300 such that the body 1486 extends through the motor 1312, the bracket 1346, and the bore 1384 of the motor shaft 1362. The body 1486 of the crankshaft 1474 also extends into the gear housing 1402 so that the pinion 1498 meshes with the internal gear 1422 of the planet carrier 1414 to operably couple the ratchet mechanism 1470 to the gear assembly 1398. The second end 1490b of the crankshaft 1474 is rotatably supported by a pair of bearings 1500a, 1500b arranged within the head 1308 of the ratchet tool 1300.

The drive bushing 1478 is arranged on the eccentric member 1494 of the crankshaft 1474. Also, the drive bushing 1478 is arranged to be received within a recess 1502 defined in the yoke 1482. As explained further in detail below, when the crankshaft 1474 is rotated by the gear assembly 1398, the drive bushing 1478 pivots the yoke 1482 in a reciprocating manner to drive the output drive 1314.

The ratchet mechanism 1470 further includes a pawl (not shown) and a forward/reverse switch for the ratchet mechanism 1470 in the form of a rotational member 1506. The rotational member 1506 has a gripping actuator 1510 that is accessible through the head 1308. The pawl is provided within the yoke 1482 and pivotably secured by a pin (not shown) that is coupled to the rotational member 1506. Also, the pawl has an angled first end and an angled second end. Each end of the pawl has a plurality of teeth configured to engage inner teeth 1518 of the yoke 1482. The gripping actuator 1510 can be used to rotate the rotational member 1506, and thus, the pawl, between a first position corresponding to a first rotational locking direction (e.g., a counterclockwise rotation about output axis 1342) of the output drive 1314 and a second position corresponding to a second rotational locking direction (e.g., a clockwise rotation about output axis 1342) of the output drive 1314.

In the first position, the first end of the pawl is configured to mesh with the inner teeth 1518 of the yoke 1482 to prevent the output drive 1314 from rotating relative to the yoke 1482 in the first direction. In other words, the pawl couples the output drive 1314 for co-rotation with the yoke 1482 in the first direction. The teeth on the first end of the pawl and/or the inner teeth 1518 of the yoke 1482 are angled to allow the teeth to slip past each other, thereby permitting the yoke 1482 to “ratchet” and rotate relative to the output drive 1314 in the second direction. In the second position, the second end of the pawl is configured to engage the inner teeth of the yoke 1482 to prevent the output drive 1314 from rotating relative to the yoke 1482 in the second direction. In other words, the pawl couples the output drive 1314 for co-rotation with the yoke 1482 in the second direction. The teeth on the second end of the pawl and/or the inner teeth 1518 of the yoke 1482 are angled to allow the teeth to slip past each other, thereby permitting the yoke 1482 to “ratchet” and rotate relative to the output drive 1314 in the first direction.

In operation, the user engages the actuator to energize the motor 1312 and rotate the motor shaft 1362 about the motor axis 1338. The external gear 1394 formed on the motor shaft 1362 also rotates to permit rotation of the plurality of planet gears 1410. Rotation of the planet gears 1410 causes the planet carrier 1414 to rotate and drive rotation of the crankshaft 1474. The crankshaft 1474 rotates the drive bushing 1478, which causes the yoke 1482 to pivot in a reciprocating manner relative to the head 1308 of the powered ratchet tool 1300. The yoke 1482 then transfers torque to the output drive 1314 to either tighten or loosen a workpiece.

In the illustrated embodiment of the powered ratchet tool 1300, the gear assembly 1398 is disposed within the handle housing 1304 and rearward of the motor 1312. Positioning the gear assembly 1398 rearward of the motor 1312, rather than in front of the motor 1312, allows for a small sized head (i.e., the head 1308) of the ratchet tool 1300. In other embodiments, the gear assembly 1398 may be a two-speed transmission including a gear selector for selecting a specific speed state. Placing the gear assembly 1398 and the gear selector rearward of the motor 1312 will position the gear selector closer to a user's hand for easier operation of the powered ratchet tool 1300.

Referring back to FIG. 15, the motor shaft 1362 extends out of the end of the gear assembly 1398 and an external slider 1600 is coupled thereto. The external slider 1600 may be used to manually slide the motor shaft 1362 within the gear assembly 1398 to change the direction of rotation of the powered ratchet tool 1300 during operation thereof.

Although the disclosure has been described in detail with reference to certain preferred embodiments, variations and modifications exist within the scope and spirit of one or more independent aspects of the disclosure as described.

What is claimed is:

1. A powered ratchet comprising:
a housing;
a motor having a motor shaft, the motor shaft being rotatable in a forward direction and a reverse direction;
a ratchet drive shaft coupled to the motor shaft and including an eccentric drive member;
a ratchet assembly including
a yoke coupled to the eccentric drive member such that the yoke reciprocates about an output drive axis in response to rotation of the ratchet drive shaft, and
an output drive selectively coupled to the yoke by a pawl mechanism such that:
the output drive is coupled for co-rotation with the yoke in a first direction, and the yoke is rotatable relative to the output drive in a second direction opposite the first direction, when the pawl mechanism is in a first configuration, and
the output drive is coupled for co-rotation with the yoke in the second direction, and the yoke is rotatable relative to the output drive in the first direction, when the pawl mechanism is in a second configuration; and
an actuator operable to move the pawl mechanism between the first configuration and the second configuration in response to rotation of the motor shaft changing direction.

2. The powered ratchet of claim 1, wherein the actuator is disposed on the eccentric drive member of the ratchet drive shaft.

3. The powered ratchet of claim 2, wherein the eccentric drive member is formed with an external thread and the actuator is formed with a complementary internal thread such that relative rotation between the eccentric drive member and the actuator causes axial movement of the actuator.

4. The powered ratchet of claim 1, further comprising a transmission coupled between the motor shaft and the ratchet drive shaft.

5. The powered ratchet of claim 4, wherein the actuator is disposed within the transmission.

6. The powered ratchet of claim 5, wherein the transmission includes a helical sun gear coupled to the motor shaft, a plurality of helical planet gears mounted on a planet gear carrier around the helical sun gear, and a fixed helical ring gear around the plurality of helical planet gears, and wherein the actuator comprises the plurality of helical planet gears and the planet gear carrier.

7. The powered ratchet of claim 6, wherein as the motor shaft rotates in the forward direction, the actuator translates linearly along the helical sun gear within the fixed helical ring gear, to a forward drive position.

8. The powered ratchet of claim 7, wherein as the motor shaft rotates in the reverse direction, the actuator translates linearly along the helical sun gear within the fixed helical ring gear to a reverse drive position.

9. The powered ratchet of claim 1, wherein the pawl mechanism includes a forward drive pawl that engages the output drive when the actuator is in a forward drive position to define the first configuration of the pawl mechanism.

10. The powered ratchet of claim 9, wherein the pawl mechanism includes a reverse drive pawl that engages the output drive when the actuator is in a reverse drive position to define the second configuration of the pawl mechanism.

11. The powered ratchet of claim 10, wherein the forward drive pawl and the reverse drive pawl are supported within the yoke.

12. A powered ratchet comprising:
a housing;
a motor having a motor shaft, the motor shaft being rotatable in a forward direction and a reverse direction;
a ratchet assembly including
a yoke coupled to the motor shaft such that the yoke reciprocates about an output drive axis in response to rotation of the motor shaft, and
an output drive selectively coupled to the yoke by a pawl mechanism such that:
the output drive is coupled for co-rotation with the yoke in a first direction, and the yoke is rotatable relative to the output drive in a second direction opposite the first direction, when the pawl mechanism is in a first configuration, and
the output drive is coupled for co-rotation with the yoke in the second direction, and the yoke is rotatable relative to the output drive in the first direction, when the pawl mechanism is in a second configuration; and
an actuator coupled to the motor shaft and receiving a rotational input therefrom, the actuator translating between a first position and a second position to move the pawl mechanism between the first configuration and the second configuration in response to rotation of the motor shaft changing directions.

13. The powered ratchet of claim 12, further comprising a ratchet drive shaft coupled to the motor shaft to rotate therewith, the ratchet drive shaft including an eccentric drive member, the eccentric drive member coupled to the yoke such that the yoke reciprocates about the output drive axis in response to rotation of the ratchet drive shaft.

14. The powered ratchet of claim 13, wherein the eccentric drive member is formed with an external thread and the actuator is formed with a complementary internal thread such that relative rotation between the eccentric drive member and the actuator translates the actuator between the first position and the second position.

15. The powered ratchet of claim 13, further comprising a transmission coupled between the motor shaft and the ratchet drive shaft.

16. The powered ratchet of claim 15, wherein the actuator is disposed within the transmission.

17. The powered ratchet of claim 16, wherein the transmission includes a helical sun gear coupled to the motor shaft, a plurality of helical planet gears mounted on a planet gear carrier around the helical sun gear, and a fixed helical ring gear around the plurality of helical planet gears, and wherein the actuator comprises the plurality of helical planet gears and the planet gear carrier.

18. The powered ratchet of claim 17, wherein as the motor shaft rotates in the forward direction, the actuator translates linearly along the helical sun gear within the fixed helical ring gear, to a forward drive position.

19. The powered ratchet of claim 17, wherein as the motor shaft rotates in the reverse direction, the actuator translates linearly along the helical sun gear within the fixed helical ring gear to a reverse drive position.

20. A powered ratchet comprising:
a housing;
a motor having a motor shaft, the motor shaft being rotatable in a forward direction and a reverse direction;
a ratchet drive shaft coupled to the motor shaft and including an eccentric drive member;
a ratchet assembly including
a yoke coupled to the eccentric drive member such that the yoke reciprocates about an output drive axis in response to rotation of the ratchet drive shaft, and
an output drive selectively coupled to the yoke by a pawl mechanism such that:
the output drive is coupled for co-rotation with the yoke in a first direction, and the yoke is rotatable relative to the output drive in a second direction opposite the first direction, when the pawl mechanism is in a first configuration, and
the output drive is coupled for co-rotation with the yoke in the second direction, and the yoke is rotatable relative to the output drive in the first direction, when the pawl mechanism is in a second configuration; and
an actuator operable to move the pawl mechanism between the first configuration and the second configuration in response to rotation of the motor shaft changing direction, the actuator movable between a forward drive position and a reverse drive position,
wherein the pawl mechanism includes a forward drive pawl that engages the output drive when the actuator is in a forward drive position to define the first configuration of the pawl mechanism, and a reverse drive pawl that engages the output drive when the actuator is in a reverse drive position to define the second configuration of the pawl mechanism.
